(19) United States
(12) Patent Application Publication
(10) Pub. No.: US 2008/0299303 A1
(43) Pub. Date: Dec. 4, 2008

(54) METHOD OF MANUFACTURING OPTICAL DEVICE

(75) Inventors: Suguru Kobayashi, Nagano-shi (JP); Toru Negishi, Nagano-shi (JP); Takuya Oda, Nagano-shi (JP); Hideaki Sakaguchi, Nagano-shi (JP)

Correspondence Address: DRINKER BIDDLE & REATH (DC), 1500 K STREET, N.W., SUITE 1100, WASHINGTON, DC, 20005-1209, US

(73) Assignee: Shinko Electric Industries Co., Ltd., Nagano-shi (JP)

(21) Appl. No.: 12/107,989

(22) Filed: Apr. 23, 2008

(30) Foreign Application Priority Data
Apr. 26, 2007 (JP) 2007-117213

(51) Int. Cl. B05D 5/06

(52) U.S. Cl. 427/164

(57) ABSTRACT

An optical device includes a translucent member, and a light shielding member formed on the translucent member and having a first opening. A portion of the light shielding member corresponding to a side surface of the first opening is formed into an inclined surface. A method of manufacturing the optical device includes: forming a mask having a second opening on the translucent member such that the second opening corresponds to a shape and a forming area of the light shielding member; filling a Cr-containing resin, in which particles containing Cr are contained in a resin, into the second opening by a printing method; curing the Cr-containing resin filled in the opening to form the light shielding member made of the cured Cr-containing resin; and removing the mask.

This application is based on and claims priority from Japanese Patent Application No. 2007-117213, filed on Apr. 26, 2007, the entire contents of which are hereby incorporated by reference.

### BACKGROUND OF THE INVENTION

1. Technical Field

The present disclosure relates to an optical device and, more particularly, to an optical device used in a projector, an optical switch, a bar code reader, a copying machine, and the like.

2. Related Art

An optical device 100 shown in FIG. 1 is built in the equipment such as the projector, the optical switch, the bar code reader, the copying machine, or the like.

FIG. 1 is a sectional view of the optical device in the related art. In FIG. 1, J denotes a traveling direction of a light emitted from a light source 111, and K denotes a traveling direction of a light reflected by a mirror 114.

By reference to FIG. 1, the optical device 100 in the related art has a frame 101, a translucent member 102, a light shielding member 103, antireflection (AR) coatings 104, 105, a mirror element 108, and an airtight member 109.

The frame 101 has a fitting portion 112 to which the translucent member 102 is fitted. The fitting portion 112 is formed to pass through the frame 101. The frame 101 is provided to support the translucent member 102.

The translucent member 102 is fitted into the fitting portion 112 of the frame 101. The translucent member 102 is arranged to oppose to a plurality of mirrors 114 provided to the mirror element 108. The translucent member 102 transmits the light emitted from the light source 111 and emits the light reflected by a plurality of mirrors 114 to the outside of the optical device 100.

The light shielding member 103 is formed to extend from a lower surface 102B of the translucent member 102 to a lower surface 101B of the frame 101. The light shielding member 103 is formed into a picture-frame shape, and has an opening 116. The opening 116 is provided to pass through the light transmitted through the translucent member 102 to a plurality of mirrors 114. The opening 116 is formed such that its width is extended outward from the lower surface 102B of the translucent member 102. A portion of the light shielding member 103 corresponding to a side surface of the opening 116 is shaped into an inclined surface 117. The portion of the light shielding member 103 corresponding to the inclined surface 117 prevents such an event that the light emitted from the light source 111 arrives at the mirror 114 via the light shielding member 103. An inclination angle θₓ of the inclined surface 117 of the light shielding member 103 to a surface 103A of the light shielding member 103 (a surface of the light shielding member 103 contacting the lower surface 102B of the translucent member 102) is set to a given angle (e.g., 30 degree). When this inclination angle θₓ is different from the given angle, a projection frame of the image being formed by a light reflected by a plurality of mirrors 114 (a projected light) is blurred. For this reason, it is very important to form the opening 116 such that the inclination angle θₓ is set to the given angle.

The light shielding member 103 is provided to restrict a reflection area of the light reflected by a plurality of mirrors 114 and also apply directly the light emitted from the light source 111 onto a plurality of mirrors 114. In other words, the light shielding member 103 functions as the projection frame of the image being formed by the light reflected by a plurality of mirrors 114 (the projected light) and prevents such an event that a noise (e.g., light scattering) is generated in the light reflected by a plurality of mirrors 114 (the projected light).

As the light shielding member 103, a Cr/CrₓO_{y}/Cr multilayer film formed by providing a Cr layer, a CrₓO_{y} layer, and Cr layer in order, for example, can be employed. A thickness of the Cr/CrₓO_{y}/Cr multilayer film can be set to 170 μm, for example.

The AR coating 104 is applied to cover an upper surface 102A of the translucent member 102. The AR coating 104 is applied to prevent that the light emitted from the light source 111 is reflected by the upper surface 102A of the translucent member 102.

The AR coating 105 is applied to cover a portion of the lower surface 102B, which is exposed from the opening 116, of the translucent member 102 and the light shielding member 103. The AR coating 105 is applied to prevent such a situation that the light reflected by a plurality of mirrors 114 is reflected by the lower surface 102B of the translucent member 102.

The mirror element 108 is fixed to the frame 101 via the AR coating 105. The mirror element 108 has a plurality of mirrors 114. The mirrors 114 are used to reflect the light emitted from the light source 111 to the outside of the optical device 100 via the translucent member 102 and the AR coatings 104, 105. A space L is formed between the mirror element 108 and the portion of AR coating 105, which corresponds to the area where the opening 116 is formed. The space L enables a plurality of mirrors 114 to move without contacting the AR coating 105. The space L is sealed in an airtight manner by the airtight member 109 that is provided between the AR coating 105 and the mirror element 108.

FIG. 2 to FIG. 8 are views showing the steps of manufacturing the optical device in the related art. In FIG. 2 to FIG. 8, the same reference symbols are affixed to the same constituent portions as those of the optical device 100 shown in FIG. 1 in the related art.

A method of manufacturing the optical device 100 in the related art will be described with reference to FIG. 2 to FIG. 8 hereunder. At first, in the step shown in FIG. 2, the translucent member 102 is inserted into the fitting portion 112 of the frame 101, and then this translucent member 102 is deposited to the frame 101.

Then, in the step shown in FIG. 3, a Cr/CrₓO_{y}/Cr multilayer film 119 is formed to cover the lower surface 101B of the frame 101 and the lower surface 102B of the translucent member 102. The Cr/CrₓO_{y}/Cr multilayer film 119 can be formed by the method such as the sputter method, the vacuum deposition method, for example.

Then, in the step shown in FIG. 4, a resist film 121 having an opening 121A is formed on a surface 119A of the Cr/CrₓO_{y}/Cr multilayer film 119. The opening 121A is formed to expose a portion of the surface 119A of the Cr/CrₓO_{y}/Cr multilayer film 119, which corresponds to the area where the opening 116 (see FIG. 1) of the light shielding member 103 is formed, as described above.

Then, in the step shown in FIG. 5, the Cr/CrₓO_{y}/Cr multilayer film 119 provided to the structure shown in FIG. 4 is etched using the resist film 121 as a mask. Thus, the light shielding member 103 having the opening 116 is formed.

Then, in the step shown in FIG. 6, the resist film 121 shown in FIG. 5 is removed. Then, in the step shown in FIG. 7, the AR coating 104 is formed for covering the upper surface 102A of the translucent member 102 and the AR coating 105 is formed for covering the portion of the lower surface 102B of the translucent member 102, which is exposed from the opening 116, and the light shielding member 103.

Then, in the step shown in FIG. 8, the mirror element 108 is fixed to the adhesive member 109 and the AR coating 105. Thus, the optical device 100 in the related art is manufactured (see e.g., Japanese Unexamined Patent Application Publication No. 2006-145610).

However, in the optical device in the related art, the light shielding member 103 having the opening 116 is formed by etching the Cr/CrₓO_{y}/Cr multilayer film 119 that is formed to cover the lower surface of 101B of the frame 101 and the lower surface 102B of the translucent member 102.

For this reason, it is technically-difficult to control the inclined angle θₓ of the inclined surface 117 of the light shielding member 103 to the surface 103A of the light shielding member 103 (the surface of the light shielding member 103 contacting the lower surface 102B of the translucent member 102) at the given angle (e.g., 30 degree). Also, when the light shielding member 103 is formed by the method described above, a production cost of the optical device 100 is increased.

### SUMMARY OF THE INVENTION

Exemplary embodiments of the present invention provide an optical device that is capable of forming a light shielding member with good precision such that an inclined angle of an inclined surface of the light shielding member corresponding to a side surface of an opening formed in the light shielding member can be set to a given angle, and also is capable of reducing a production cost.

According to one or more aspects of the present invention, in a method of manufacturing an optical device including a translucent member for transmitting a light emitted from a light source, a mirror element disposed to oppose to the translucent member and having a plurality of mirrors for reflecting the light transmitted through the translucent member, and a light shielding member for restricting a reflection area of the light reflected by the plurality of mirrors and also having a first opening for applying directly the light transmitted through the translucent member onto the plurality of mirrors, a portion of said light shielding member corresponding to a side surface of the first opening being formed into an inclined surface, the method includes: forming a mask having a second opening on the translucent member such that the second opening corresponds to a shape and a forming area of the light shielding member; filling a Cr-containing resin, in which particles containing Cr are contained in a resin, into the second opening by a printing method; curing the Cr-containing resin filled in the opening to form the light shielding member made of the cured Cr-containing resin; and removing the mask.

According to one or more aspects of the present invention, the method further includes: forming an AR coating to cover a surface of the translucent member on which the light emitted from the light source is incident, and a surface of the translucent member opposing to the mirror element.

According to one or more aspects of the present invention, an angle between an inclined surface of the second opening and the surface of the translucent member opposing to the mirror element is a sharp angle.

According to one or more aspects of the present invention, in a method of manufacturing an optical device including a translucent member, and a light shielding member formed on the translucent member and having a first opening, a portion of said light shielding member corresponding to a side surface of the first opening being formed into an inclined surface, the method includes: forming a mask having a second opening on the translucent member such that the second opening corresponds to a shape and a forming area of the light shielding member; filling a Cr-containing resin, in which particles containing Cr are contained in a resin, into the second opening by a printing method; curing the Cr-containing resin filled in the opening to form the light shielding member made of the cured Cr-containing resin; removing the mask; and forming an AR coating to cover a first surface of the translucent member on which light emitted from a light source is incident, and a second surface of the translucent member opposing to the first surface.

According to one or more aspects of the present invention, the method further includes: disposing a mirror element having a plurality of mirrors to oppose to the translucent member.

According to one or more aspects of the present invention, an angle between an inclined surface of the second opening and the second surface is a sharp angle.

According to the present invention, the light shielding member can be formed with good precision such that an inclined angle of the inclined surface of the light shielding member corresponding to the side surface of the opening formed in the light shielding member can be set to a given angle, and also a production cost of the optical device can be reduced.

Other aspects and advantages of the invention will be apparent from the following description, the drawings and the claims.

### BRIEF DESCRIPTION OF THE DRAWINGS

FIG. 1 is a sectional view of an optical device in the related art;

FIG. 2 is a view (#1) showing the step of manufacturing the optical device in the related art;

FIG. 3 is a view (#2) showing the step of manufacturing the optical device in the related art;

FIG. 4 is a view (#3) showing the step of manufacturing the optical device in the related art;

FIG. 5 is a view (#4) showing the step of manufacturing the optical device in the related art;

FIG. 6 is a view (#5) showing the step of manufacturing the optical device in the related art;

FIG. 7 is a view (#6) showing the step of manufacturing the optical device in the related art;

FIG. 8 is a view (#7) showing the step of manufacturing the optical device in the related art;

FIG. 9 is a sectional view of an optical device according to an embodiment of the present invention;

FIG. 10 is a view (#1) showing the step of manufacturing the optical device according to the embodiment of the present invention;

FIG. 11 is a view (#2) showing the step of manufacturing the optical device according to the embodiment of the present invention;

FIG. 12 is a view (#3) showing the step of manufacturing the optical device according to the embodiment of the present invention;

FIG. 13 is a view (#4) showing the step of manufacturing the optical device according to the embodiment of the present invention;

FIG. 14 is a view (#5) showing the step of manufacturing the optical device according to the embodiment of the present invention;

FIG. 15 is a view (#6) showing the step of manufacturing the optical device according to the embodiment of the present invention;

FIG. 16 is a view (#7) showing the step of manufacturing the optical device according to the embodiment of the present invention; and

FIG. 17 is a view (#8) showing the step of manufacturing the optical device according to the embodiment of the present invention.

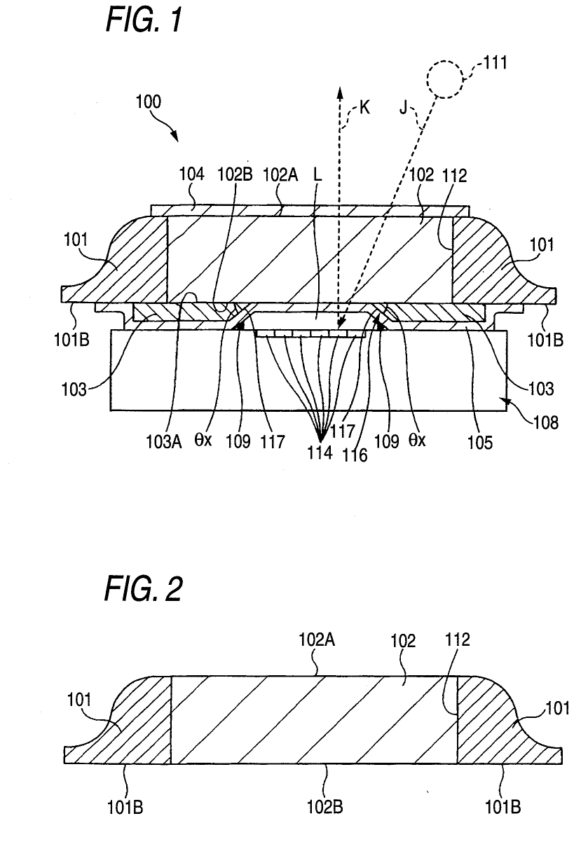

### DETAILED DESCRIPTION

An embodiment of the present invention will be described with reference to the drawings hereinafter.

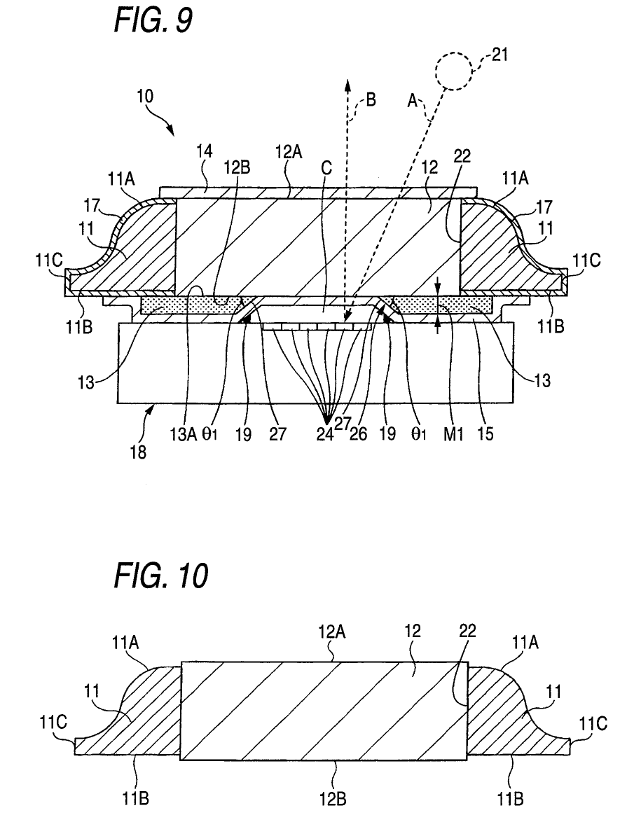

FIG. 9 is a sectional view of an optical device according to an embodiment of the present invention. In FIG. 9, A denotes a traveling direction of a light emitted from a light source 21, and B denotes a traveling direction of a light reflected by a plurality of mirrors 24.

By reference to FIG. 9, an optical device 10 of the present embodiment has a frame 11, a translucent member 12, a light shielding member 13, AR coatings 14, 15, an Ni/Au multilayer film 17, a mirror element 18, and an airtight member 19.

The frame 11 has a fitting portion 22 to which the translucent member 12 is fitted. The fitting portion 22 is formed to pass through the frame 11. The frame 11 is provided to support the translucent member 12. As the material of the frame 11, for example, Kovar (a Cu—Ni—Co alloy) can be employed.

The translucent member 12 is deposited to the fitting portion 22 of the frame 11. The translucent member 12 is arranged to oppose to a plurality of mirrors 24 provided to the mirror element 18. The translucent member 12 transmits the light emitted from the light source 21 and radiates the light reflected by a plurality of mirrors 24 to the outside of the optical device 10.

The light shielding member 13 is arranged to extend from a lower surface 12B of the translucent member 12 to a portion of a lower surface of the Ni/Au multilayer film 17 formed on a lower surface 11B of the frame 11. The light shielding member 13 is formed into a picture-frame shape, and has an opening 26. The opening 26 is provided to pass through the light transmitted through the translucent member 12 to a plurality of mirrors 24.

The opening 26 is formed such that its width is extended outward from the lower surface 12B of the translucent member 12. A portion of the light shielding member 13 corresponding to a side surface of the opening 26 is shaped into an inclined surface 27. The portion of the light shielding member 13 corresponding to the inclined surface 27 is provided to prevent such an event that the light emitted from the light source 21 arrives at the mirrors 24 via the light shielding member 13. An inclined angle θ₁ of the inclined surface 27 of the light shielding member 13 to a surface 13A of the light shielding member 13 (a surface of the light shielding member 13 contacting the lower surface 12B of the translucent member 12) is set to a given angle θ. This given angle θ can be set to 30 degree, for example.

The light shielding member 13 is provided to restrict a reflection area of the light reflected by a plurality of mirrors 24 and to radiate directly the light emitted from the light source 21 onto a plurality of mirrors 24. In other words, the light shielding member 13 functions as the projection frame of the image being formed by the light reflected by a plurality of mirrors 24 (the projected light) and prevents such an event that a noise (e.g., light scattering) is generated in the light reflected by a plurality of mirrors 24 (the projected light).

As the material of the light shielding member 13, a Cr-containing resin in which particles containing Cr are contained in a resin, for example, can be employed. In this case, a thickness M1 of the light shielding member 13 may be set to 50 μm, for example. As the resin, for example, a polyimide silicon resin may be employed. Also, as the particles containing Cr, trivalent chrome particles, for example, may be employed. When the trivalent chrome particle is used as the particle containing Cr, a particle diameter of the trivalent chrome particle may be set to 1 μm, for example. Also, when the polyimide silicon resin is employed as the resin, the trivalent chrome particles may be mixed in the Cr-containing resin at a rate of 10% to 30%, for example.

The AR coating 14 is provided to cover an upper surface 12A of the translucent member 12, and to extend from the upper surface 12A of the translucent member 12 to a portion of the Ni/Au multilayer film 17 formed on an upper surface 11A of the frame 11. The AR coating 14 is provided to prevent such a situation that the light emitted from the light source 21 is reflected by the upper surface 12A of the translucent member 12.

The AR coating 15 is provided on a lower surface of the portion, which is formed on the lower surface 11B of the frame 11, of the Ni/Au multilayer film 17 and the lower surface 12B of the portion, which is exposed from the opening 26, of the translucent member 12 to cover the light shielding member 13. The AR coating 15 prevents such a situation that the light reflected by a plurality of mirrors 24 is reflected by the lower surface 12B of the translucent member 12.

The Ni/Au multilayer film 17 is provided to cover the upper surface 11A of the frame 11, the lower surface of 11B of the frame 11, and a side surface 11C of the frame 11. The Ni/Au multilayer film 17 is formed of a Ni layer provided on the frame 11, and an Au layer provided on the Ni layer. A thickness of the Ni layer may be set to 7 μm, for example. Also, a thickness of the Au layer may be set to 5 μm, for example. The Ni/Au multilayer film 17 is provided to improve an adhesion between the frame 11 and the AR coatings 14, 15.

The mirror element 18 is fixed to the frame 11 via the AR coating 15. The mirror element 18 has a plurality of mirrors 24. The plurality of mirrors 24 are provided to reflect the light emitted from the light source 21 to the outside of the optical device 10 via the translucent member 12 and the AR coatings 14, 15. A space C is formed between the AR coating 15, which is provided on the portion of the lower surface 12B of the translucent member 12 exposed from the opening 26, and the mirror element 18. The space C enables the plurality of mirrors 24 to move without contacting the AR coating 15. The space C is sealed in an airtight manner by the airtight member 19 that is provided between the AR coating 15 and the mirror element 18. As the material of the airtight member 19, ceramic powders solidified with a resin, for example, may be employed. As the mirror element 18, Digital Micromirror Device (registered trademark of Texas Instruments Inc. in the USA), for example, may be employed.

FIG. 10 to FIG. 17 are views showing the steps of manufacturing the optical device according to the embodiment of the present invention. In FIG. 10 to FIG. 17, the same reference symbols are affixed to the same constituent portions as those of the optical device 10 according to the present embodiment.

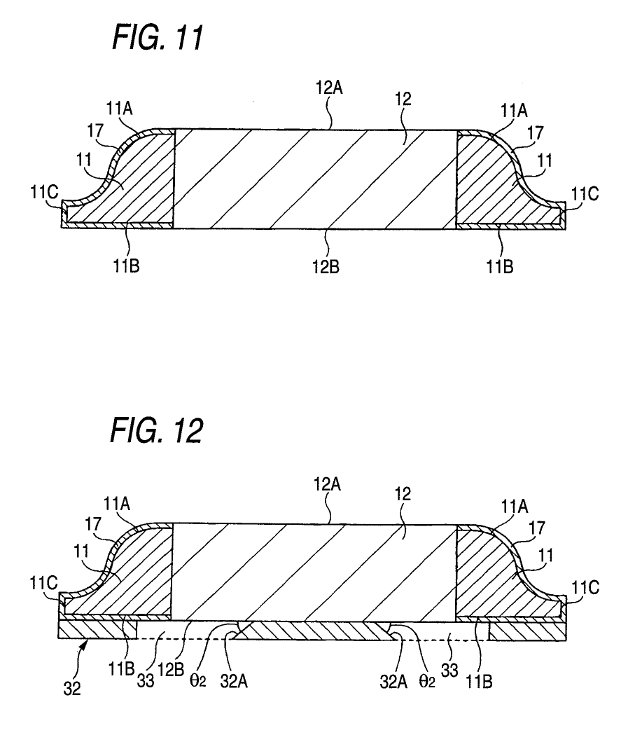

A method of manufacturing the optical device 10 of the present embodiment will be described with reference to FIG. 10 to FIG. 17 hereunder. At first, in the step shown in FIG. 10, the translucent member 12 is deposited to the fitting portion 22 of the frame 11. Then, in the step shown in FIG. 11, the Ni/Au multilayer film 17 is formed to cover the upper surface 11A of the frame 11, the lower surface 11B of the frame 11, and the side surface 11C of the frame 11. Concretely, the Ni/Au multilayer film 17 is formed by the electroplating method using the frame 11 as a power feeding layer.

Then, in the step shown in FIG. 12, a mask 32 having an opening 33 corresponding to the shape of the light shielding member 13 is arranged on the lower surface of the Ni/Au multilayer film 17 provided on the lower surface 11B of the frame 11 and the lower surface 12B of the translucent member 12. The opening 33 is formed into a picture-frame shape. A shape of the portion of the mask 32 corresponding to the inner side surface of the opening 33 is shaped into an inclined surface 32A. This inclined surface 32A is the surface that is used to form the inclined surface 27 of the light shielding member 13. An angle θ₂ between the inclined surface 32A of the mask 32 and the lower surface 12B of the translucent member 12 is set substantially equal to the inclined angle θ₁ of the inclined surface 27 of the light shielding member 13. Concretely, an angle θ₂ may be set to 30 degree, for example.

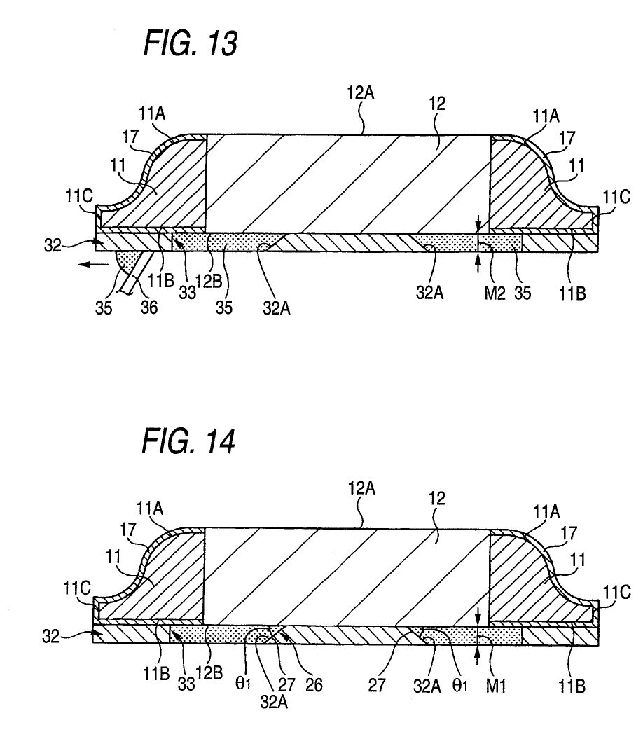

Then, in the step shown in FIG. 13, a Cr-containing resin 35 in which the particles containing Cr are contained in the resin is filled in the opening 33 of the mask 32 by the printing method. As the printing method, the squeegee printing method using a squeegee 36, for example, may be employed. As the resin constituting the Cr-containing resin 35, a polyimide silicon resin, for example, may be employed. Also, as the particles containing Cr, trivalent chrome particles, for example, may be employed. When the trivalent chrome is employed as the particles containing Cr, the particle diameter of the trivalent chrome may be set to 1 μm, for example. Also, when the polyimide silicon resin is employed as the resin, the trivalent chrome particles may be mixed in the Cr-containing resin 35 at a rate of 10% to 30%, for example. A thickness M2 of the Cr-containing resin 35 may be set to 50 μm.

Then, in the step shown in FIG. 14, the light shielding member 13 is formed in the opening 33 by curing the Cr-containing resin 35 filled in the opening 33. Concretely, for example, when the Cr-containing resin 35 is a thermosetting resin, the Cr-containing resin 35 filled in the opening 33 is cured by heating the structure shown in FIG. 13 (except the extra Cr-containing resin 35 existing on the squeegee 36 and not contained in the opening 33). A thickness M1 of the light shielding member 13 may be set to 50 μm, for example. Also, an inclined angle θ₁ of the inclined surface 27 of the light shielding member 13 to the surface 13A of the light shielding member 13 (the surface of the light shielding member 13 contacting the lower surface 12b of the translucent member 12) may be set to 30 degree (given angle θ), for example.

In this manner, the mask 32 having the opening 33 corresponding to the shape of the light shielding member 13 is arranged on the lower surface of the Ni/Au multilayer film 17, which is provided on the lower surface 11B side of the frame 11, and the lower surface 12B of the translucent member 12, then the Cr-containing resin 35 is filled in the opening 33 by the printing method, and then the light shielding member 13 is formed by curing the Cr-containing resin 35 being filled in the opening 33. As a result, the light shielding member 13 can be formed with good precision such that the inclined angle θ₁ of the inclined surface 27 of the light shielding member 13 can be set to a given angle θ.

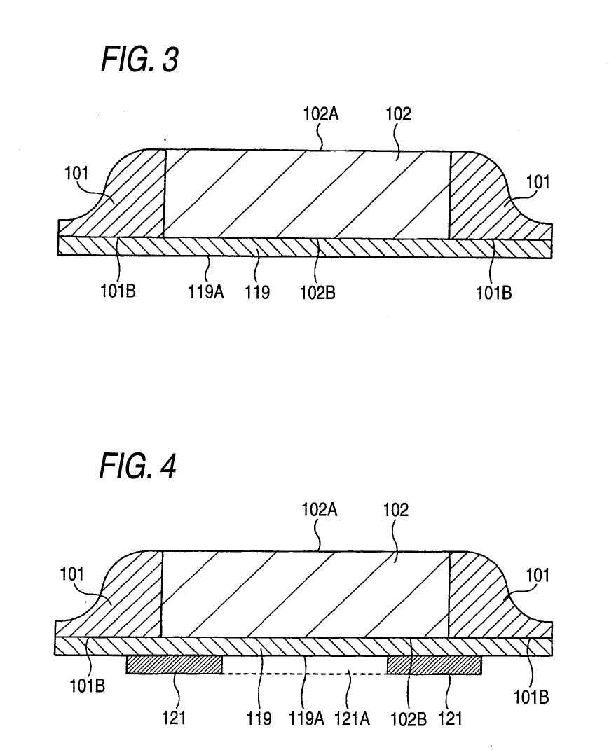

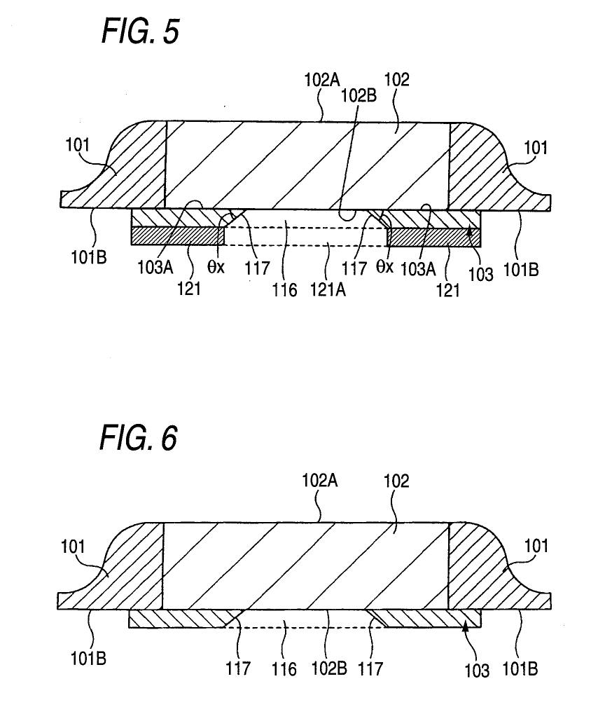

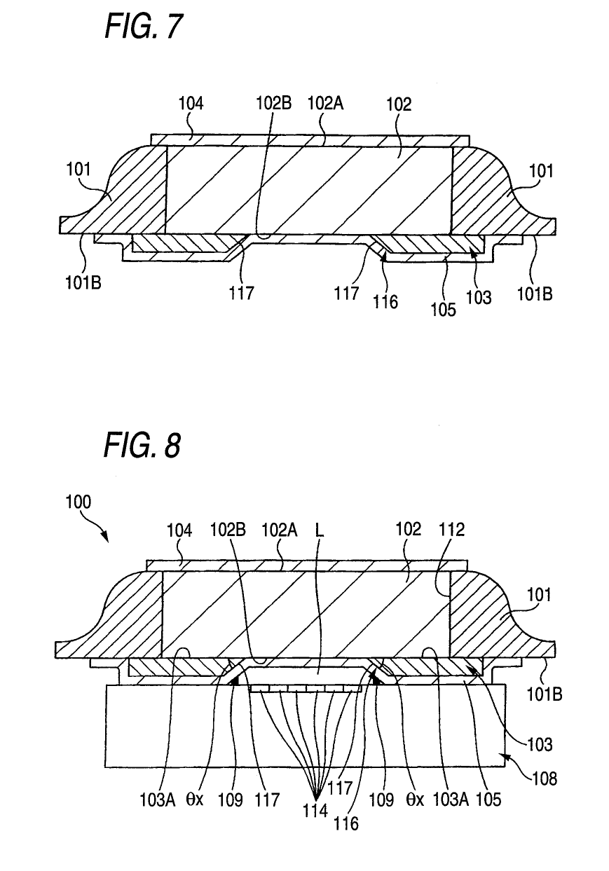

Also, since the light shielding member 13 is formed by the printing method using the mask 32, the mask 32 can be used repeatedly. As a result, a production cost of the optical device 10 can be reduced in contrast to the manufacturing method in the related art (see FIG. 2 to FIG. 6) by which the light shielding member 103 is formed by the etching process using the resist film 121.

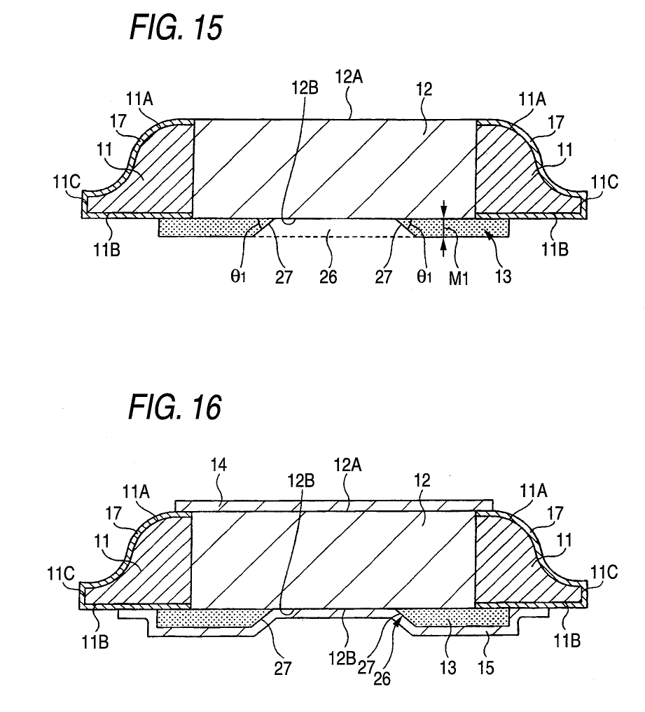

Then, in the step shown in FIG. 15, the mask 32 shown in FIG. 14 is removed from the frame 11 and the translucent member 12.

Then, in the step shown in FIG. 16, the AR coatings 14, 15 are formed by the well-known method. The AR coating 14 is provided to cover the upper surface 12A of the translucent member 12, and to extend from the upper surface 12A of the translucent member 12 to the portion of the Ni/Au multilayer film 17 formed on the upper surface 11A of the frame 11. Since the AR coating 14 is formed in this manner, such a situation can be prevented that the light emitted from the light source 21 is reflected by the upper surface 12A of the translucent member 12.

As the AR coating 14, for example, an SiO₂/Al₂O₃/LaTiO₂/MgF₂ multilayer film obtained by providing an SiO₂ film (thickness 90 nm), an Al₂O₃ film (thickness 80 nm), an LaTiO₂ film (thickness 110 nm), and an MgF₂ film (thickness 80 nm) in order on the upper surface 12A of the translucent member 12 can be employed.

The AR coating 15 is provided on the portion of the lower surface of the Ni/Au multilayer film 17, which is formed on the lower surface 11B of the frame 11, and the portion of the lower surface 12B of the translucent member 12, which is exposed from the opening 26, to cover the light shielding member 13. Since the AR coating 15 is formed in this manner, such a situation can be prevented that the light reflected by a plurality of mirrors 24 is reflected by the lower surface 12B of the translucent member 12.

As the AR coating 15, for example, an SiO₂/Al₂O₃/LaTiO₂/MgF₂ multilayer film obtained by providing an SiO₂ film (thickness 90 nm), an Al₂O₃ film (thickness 80 nm), an LaTiO₂ film (thickness 110 nm), and an MgF₂ film (thickness 80 nm) in order on the lower surface 12B of the translucent member 12 can be employed. The AR coatings 14, 15 can be formed by the method such as the sputter method, the vacuum deposition method, or the like, for example.

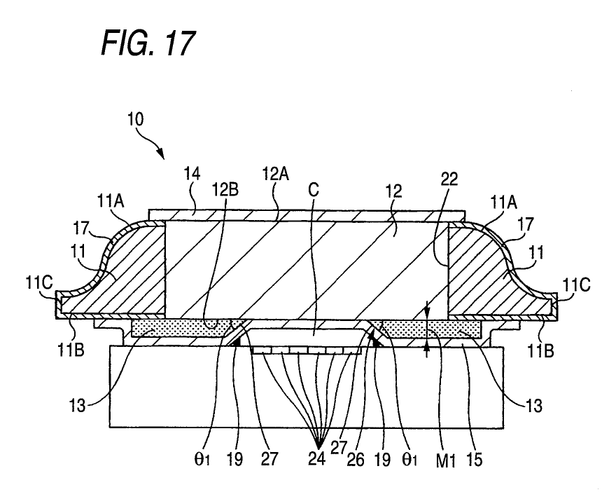

Then, in the step shown in FIG. 17, the mirror element 18 is fixed to the frame 11 via the AR coating 15 and the airtight member 19. Thus, the optical device 10 of the present embodiment is manufactured.

According to the method of manufacturing the optical device of the present embodiment, the mask 32 having the opening 33 corresponding to the shape of the light shielding member 13 is arranged on the lower surface of the Ni/Au multilayer film 17, which is provided on the lower surface 11B side of the frame 11, and the lower surface 12B of the translucent member 12, then the Cr-containing resin 35 is filled in the opening 33 by the printing method, and then the light shielding member 13 is formed by curing the Cr-containing resin 35 being filled in the opening 33. As a result, the light shielding member 13 can be formed with good precision such that the inclined angle θ₁ of the inclined surface 27 of the light shielding member 13 can be set to a given angle θ.

Also, since the light shielding member 13 is formed by the printing method using the mask 32, the mask 32 can be used repeatedly. As a result, a production cost of the optical device 10 can be reduced in contrast to the manufacturing method in the related art (see FIG. 2 to FIG. 6) by which the light shielding member 103 is formed by the etching process using the resist film 121.

In this case, in the optical device 10 of the present embodiment, while the light shielding member 13 is provided on the lower surface 12B side of the translucent member 12 as an exemplary embodiment, the light shielding member 13 may be formed on the upper surface 12A side of the translucent member 12 by using the similar approach to the above manufacturing method. Also, after applying the AR coatings 14, 15, the light shielding member 13 may be formed on the AR coatings 14, 15 by using the similar approach to the above manufacturing method.

The present invention may be applicable to the optical device that is built in a projector, an optical switch, a bar code reader, a copying machine, and the like.

While the present invention has been shown and described with reference to certain exemplary embodiments thereof, it will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

What is claimed is:

1. A method of manufacturing an optical device including a translucent member for transmitting a light emitted from a light source, a mirror element disposed to oppose to the translucent member and having a plurality of mirrors for reflecting the light transmitted through the translucent member, and a light shielding member for restricting a reflection area of the light reflected by the plurality of mirrors and also having a first opening for applying directly the light transmitted through the translucent member onto the plurality of mirrors, a portion of said light shielding member corresponding to a side surface of the first opening being formed into an inclined surface,
the method comprising:
forming a mask having a second opening on the translucent member such that the second opening corresponds to a shape and a forming area of the light shielding member;
filling a Cr-containing resin, in which particles containing Cr are contained in a resin, into the second opening by a printing method;
curing the Cr-containing resin filled in the opening to form the light shielding member made of the cured Cr-containing resin; and
removing the mask.

2. The method of claim 1, further comprising:
forming an AR coating to cover a surface of the translucent member on which the light emitted from the light source is incident, and a surface of the translucent member opposing to the mirror element.

3. The method of claim 2, wherein an angle between an inclined surface of the second opening and the surface of the translucent member opposing to the mirror element is a sharp angle.

4. A method of manufacturing an optical device including a translucent member, and a light shielding member formed on the translucent member and having a first opening, a portion of said light shielding member corresponding to a side surface of the first opening being formed into an inclined surface,
the method comprising:
forming a mask having a second opening on the translucent member such that the second opening corresponds to a shape and a forming area of the light shielding member;
filling a Cr-containing resin, in which particles containing Cr are contained in a resin, into the second opening by a printing method;
curing the Cr-containing resin filled in the opening to form the light shielding member made of the cured Cr-containing resin;
removing the mask; and
forming an AR coating to cover a first surface of the translucent member on which light emitted from a light source is incident, and a second surface of the translucent member opposing to the first surface.

5. The method of claim 4, further comprising:
disposing a mirror element having a plurality of mirrors to oppose to the translucent member.

6. The method of claim 5, wherein an angle between an inclined surface of the second opening and the second surface is a sharp angle.
